(19) United States
(12) Patent Application Publication
(10) Pub. No.: US 2020/0137983 A1
(43) Pub. Date: May 7, 2020

(54) LIVESTOCK MANAGEMENT SYSTEM

(71) Applicants: Lynn Nieveen, Hickman, NE (US); Travis Meyer, Hickman, NE (US); Mike Ciholas, Newburgh, IN (US); Paul Blaylock, Newburgh, IN (US); Evan Buchanan, Newburgh, IN (US)

(72) Inventors: Lynn Nieveen, Hickman, NE (US); Travis Meyer, Hickman, NE (US); Mike Ciholas, Newburgh, IN (US); Paul Blaylock, Newburgh, IN (US); Evan Buchanan, Newburgh, IN (US)

(21) Appl. No.: 16/625,182

(22) PCT Filed: Jun. 29, 2018
(86) PCT No.: PCT/US18/40194

§ 371 Date: Dec. 20, 2019

Related U.S. Application Data
(60) Provisional application No. 62/527,434, filed on Jun. 30, 2017.
(60) Provisional application No. 62/527,455, filed on Jun. 30, 2017.
(60) Provisional application No. 62/527,472, filed on Jun. 30, 2017.
(60) Provisional application No. 62/527,490, filed on Jun. 30, 2017.

(51) Int. Cl. A01K 29/00; A01K 11/00; A01K 5/01; H04B 1/3827

(52) U.S. Cl. CPC A01K 29/005; A01K 11/004; H04W 84/18; H04B 1/3827; A01K 5/01

(57) ABSTRACT

A tag device for placement on a livestock animal can generally include a first communications interface, a second communications interface, one or more batteries, and a local controller. A base station can be configured for bidirectional communications with a plurality of mobile communication units, which may be mobile tag devices (e.g., being made mobile by being carried by a corresponding livestock animal). A low-frequency emitting system for identifying a feed lot feature can generally include at least one wire loop and a wire driver coupled to the wire loop. The wire loop can be physically associated with or positioned adjacent to the feed lot feature. A data silo may generally include a transceiver, a memory, and a processor. The transceiver is configured to receive a plurality of historical data sets pertaining to respective livestock animals from a base station.

### BACKGROUND

Livestock systems are available that provide, e.g., for the penning, watering, and/or feeding of the livestock. As used herein, the term “livestock” refers to any animal or group of animals which is intended to be monitored and/or managed, regardless of whether the animal(s) is domesticated, semi-domesticated or wild, and regardless of the environment in which the animal may be found, such as, for example, in a commercial animal operation, or in a wild environment.

### DRAWINGS

The Detailed Description is described with reference to the accompanying figures.

FIG. 1 is a diagrammatic illustration of a tracking system for tracking livestock in accordance with an example embodiment of the present disclosure.

FIG. 2 is a diagrammatic illustration of a tracking system for tracking livestock in accordance with an example embodiment of the present disclosure.

FIG. 3 is a diagrammatic illustration of a main controller and base stations for a tracking system in accordance with an example embodiment of the present disclosure.

FIG. 4 is a diagrammatic illustration of a base station and transceivers for a tracking system in accordance with an example embodiment of the present disclosure.

FIG. 5 is a diagrammatic illustration of a base station for a tracking system in accordance with an example embodiment of the present disclosure.

FIG. 6 is a diagrammatic illustration of a transceiver for a tracking system in accordance with an example embodiment of the present disclosure.

FIG. 7 is a diagrammatic illustration of a feedlot with a tracking system for tracking livestock in accordance with an example embodiment of the present disclosure.

FIG. 8 is a diagrammatic illustration of a feedlot with a tracking system for tracking livestock in accordance with an example embodiment of the present disclosure.

FIG. 9 is a diagrammatic illustration of a feedlot with a tracking system for tracking livestock in accordance with an example embodiment of the present disclosure.

FIG. 10 is a side elevation view illustrating a cow in a feeding orientation proximate to a feeding trough in accordance with an example embodiment of the present disclosure.

FIG. 11 is a side elevation view illustrating a cow proximate to a feeding trough, where the cow is not in a feeding orientation in accordance with an example embodiment of the present disclosure.

FIG. 12 is a side elevation view illustrating a cow proximate to a feeding trough with a wire loop extending along the feeding trough in accordance with an example embodiment of the present disclosure.

FIG. 13 is a side elevation view illustrating a cow proximate to a feeding trough with a wire loop extending through the feeding trough in accordance with an example embodiment of the present disclosure.

FIG. 14 is a perspective view illustrating a transceiver for a tracking system in accordance with an example embodiment of the present disclosure.

FIG. 15 is another perspective view of the transceiver illustrated in FIG. 14, where a cover has been removed.

FIG. 16 is a further perspective view of the transceiver illustrated in FIG. 14.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

The tracking and monitoring of livestock in varying environments is often an issue of significant importance. An example of one such environment which will be used to illustrate the present system is a commercial livestock operation, such as a feedlot having multiple pens, wherein animals such as cattle or swine are raised for food or animals such as alpacas or sheep are raised primarily for their wool. A commercial feedlot provides a good example of a system for monitoring and managing livestock, in that most foreseeable actions of pertinence to livestock management are typically found in the feedlot environment. In a conventional feedlot, animals will be moved, both individually and in groups, multiple times through the weeks or months they are typically present at the feedlot. Additionally, such feedlots in the U.S., such as are used for cattle, typically have substantial numbers of animals to manage; from a few thousand animals to a few hundred thousand animals may be present at any one time. Additionally, as the profitability of the feedlot operation depends upon effective management of the livestock, including its care and feeding, the collection and correlation of data about the animals for management and review is a paramount concern. The livestock in the feedlot may also encompass exotic animals (e.g., zoo animals) raised, for example, display and/or conservation purposes. However, it should be noted that a feedlot is provided by way of example and is not meant to limit the present disclosure. In other embodiments, tracking and monitoring of livestock in accordance with the present disclosure may be conducted in other areas, including, but not necessarily limited to: a pasture, a paddock, an enclosed pasture (e.g., a fenced off pasture), a controlled grazing environment, and so forth.

Accordingly, in the feedlot environment, there is a recognized need to be able to identify the animals within the operation, and to have a data repository of information about those animals. There is also a recognized need to be able to access that data repository well after an animal has left the feedlot operation. For example, there have been numerous examples of animals carrying disease or otherwise being sick. For efficiency and/or safety of the operation, it is beneficial to notice such animals as soon as possible. It may also be useful to have overall watering and/or feeding data for a herd or segments (e.g., based on age, breed, etc.) of a herd (e.g., sufficient watering during hotter periods), in part, to manage food and/or water availability.

Tag identification systems can be used to identify an individual animal within an operation. In some embodiments, a tag, such an ear tag affixed to an animal's ear, is identified by the properties of a physical tag, such as the color of the tag and/or a number printed on the tag. In some embodiments, the ear tag associated with an individual animal is identified using an electromagnetic-based signal (e.g., passive, machine-readable radio frequency identification (“RFID”)). The use of a machine-readable RFID tag enables some automation of logging the presence of an animal when it is within the range of an RFID interrogator. The term “tag” as used herein relates to any device capable of the functionalities as described herein, regardless of how the device may be associated with an animal, such as by being externally affixed to the animal (for example, in the manner of ear tags, by a collar, or by some other mechanism), or by being implanted or otherwise internally carried by the animal. In some embodiments, the tag is located on, within, or proximate to an animal's head to facilitate locating an animal when, for example, actively eating at a feed trough and/or drinking from a water source.

Electromagnetic-based tagging of livestock has some operational similarities to inventory management systems used by retailers. Retailers utilize radio-frequency identification (RFID) technology for inventory tracking purposes. Machine-readable tags are affixed to each item to be tracked. Base stations (e.g., interrogators) are then used to poll tags within a zone of coverage to identify items within that zone. Such use of RFID technology by retailers has met the inventory tracking and management needs of the retailers while reducing costs.

The tracking and managing of livestock, however, can present substantially different considerations and challenges than monitoring an inanimate retail product. These challenges relate not only to the possibility of movement of the animal based on a choice of the animal, but more importantly also to the nature of information which is significant when monitoring livestock. Livestock can often undergo not only changes in physical location, but other changes which may beneficially be tracked and recorded. For example, in the identified example of an individual animal in a feedlot, such changes may include: vaccinations, inoculations or other medical treatments; relocation to or from another location and/or entity; groupings with other animals; and changes in the animal's weight or other physical characteristics. The ability to monitor the living patterns (e.g., movement, eating, drinking) of a herd of livestock, livestock groups (e.g., age, sex, breed), and/or individual animals may provide insight into the health and/or well-being of such animals and may help in managing provision (e.g., feed, water) availability (e.g., favorite feeding times may change; more water may be needed at peak times; etc.).

The electromagnetic-based tag can be configured to register, process, and otherwise communicate using low frequency signals, for example, very low frequency (VLF) signals. The VLF band is a specific band width that lies outside the band widths used for RFID tags (e.g., 120 kHz (kilohertz) and up, depending on the type of RFID used). In some embodiments, the VLF band may be in a range of 50 kHz (kilohertz) or less. Per an embodiment, the VLF band, as set forth by is the ITU (International Telecommunication Union), is in the range of 3 kHz to 30 kHz. In some embodiments, the VLF band is chosen so as to facilitate magnetic coupling of a given signal with the antenna of the tag device. In some embodiments, the use of a VLF detection range as part of the electromagnetic-based tag facilitates a signal detection and/or communication at short ranges (e.g., only within four (4) feet or less of a signal wire), which can be beneficial in determining, for example, that an animal is, indeed, drinking from a water source or eating at a feed trough and not simply in a general proximity of the water source or the feed trough. In some embodiments, the VLF communication capability can help avoid potential signal collision issues, in part, because the magnetic portion of a given VLF wave is being utilized. In some embodiments, the VLF communications may not be affected by environmental factors such as a temperature and/or humidity, unlike RFID devices whose results may be skewed by such factors.

Example Implementations

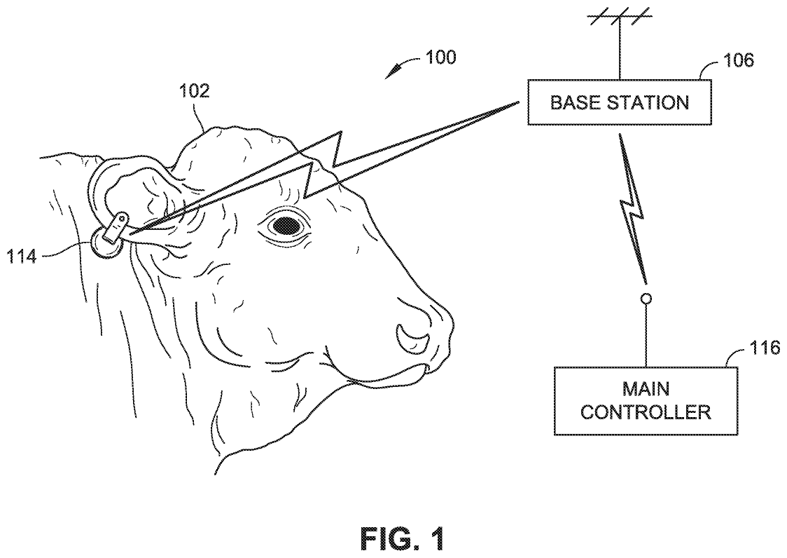

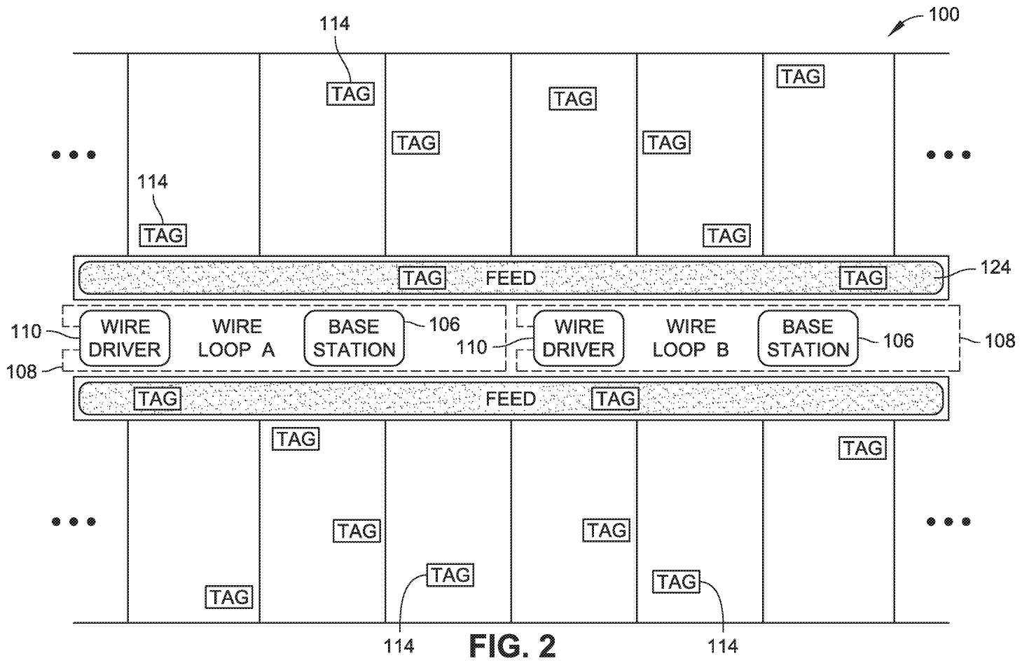

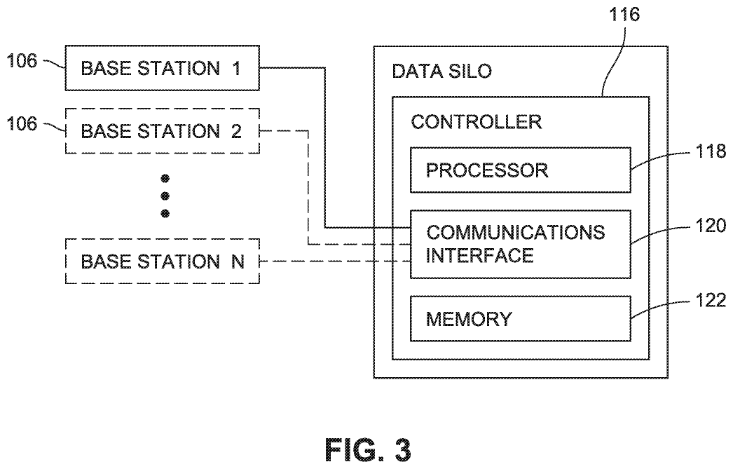

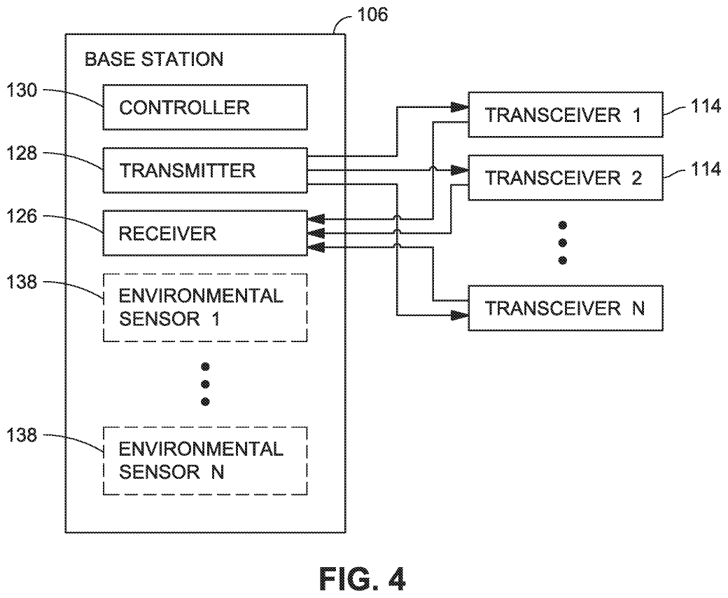

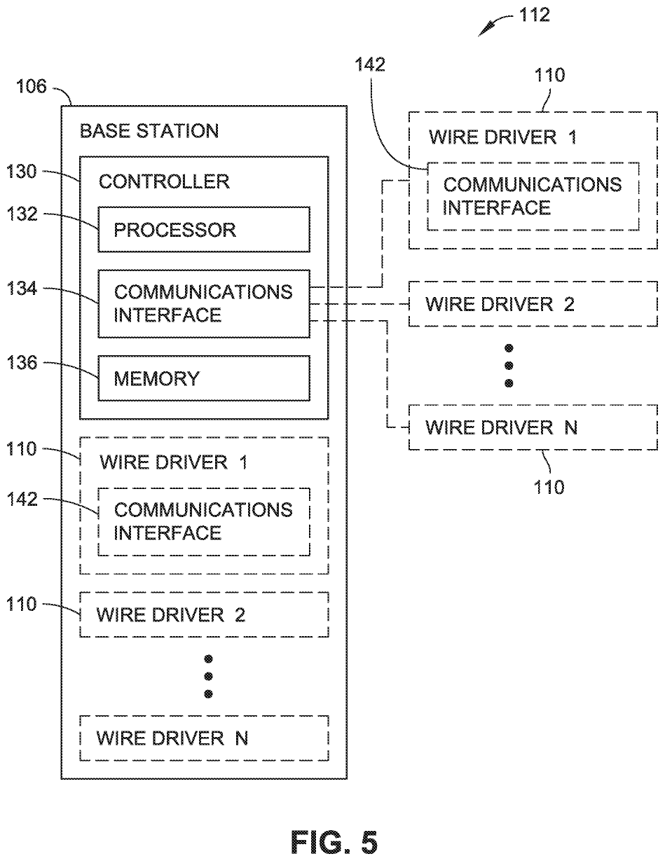

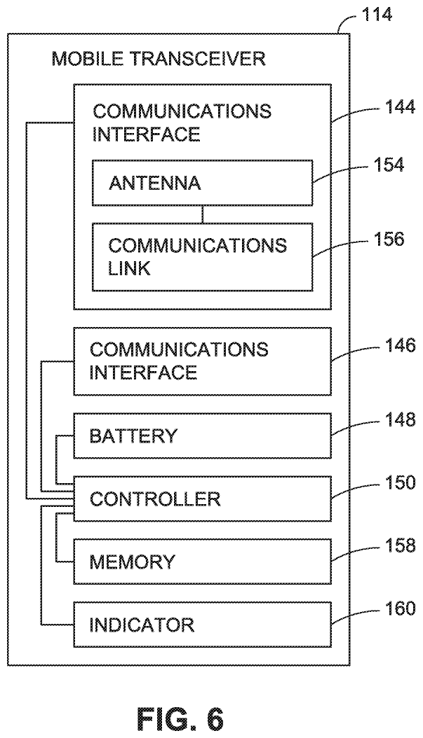

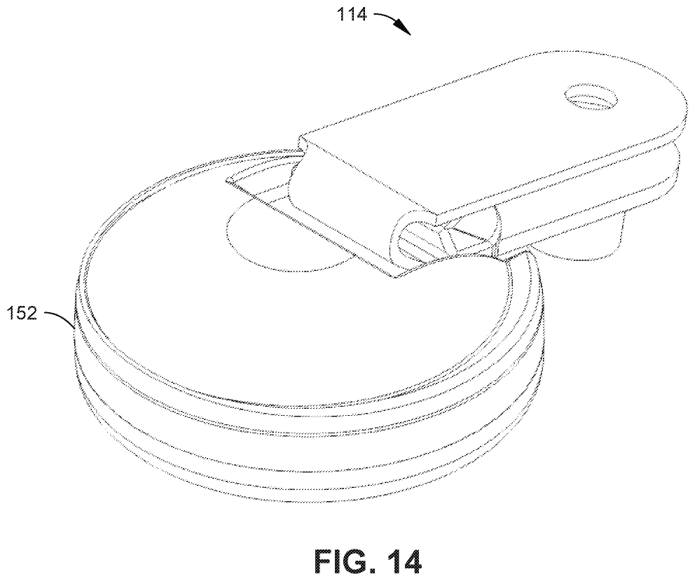

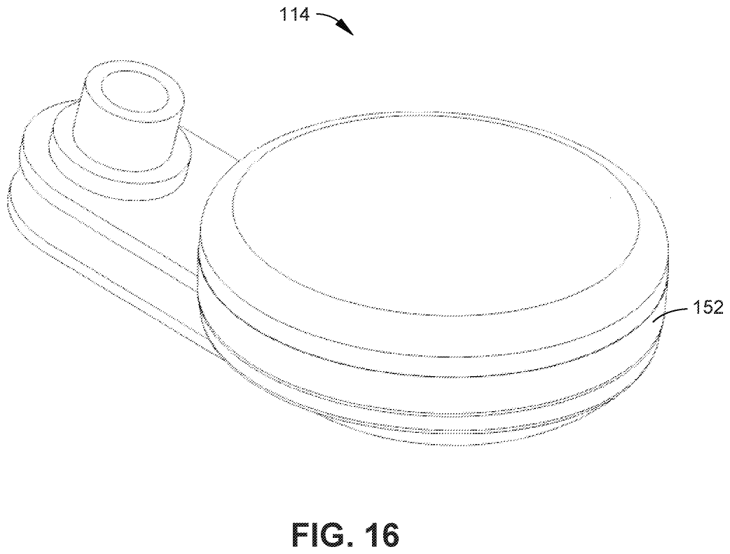

FIGS. 1 through 16 illustrate a tracking system 100 for tracking livestock, in accordance with an embodiment of the present disclosure. The tracking system 100 for tracking one or more livestock animals 102 (e.g., cattle per the illustrated example) in a feedlot 104 or another livestock penning arrangement can include one or more base stations 106 (e.g., a base communication and/or control unit), one or more wire loops 108 (i.e., a wire circuit loop interconnected with a related wire driver 110 that can together serve as a low-frequency emitting system 112), and a respective livestock tag device 114 (e.g., an ear tag, per the illustrated embodiment) (hereinafter also referred to as a “tag device,” “tag transceiver,” or “mobile transceiver”) for each livestock animal 102, and a main controller 116.

In some embodiments, the main controller 116 is configured to operatively control and communicate with each respective base station 106, each respective wire loop 108, and each respective tag device 114. In some embodiments, the main controller 116 communicates directly (e.g., wirelessly or hard-wired) with the base stations 106 and indirectly, through the one or more base stations 106, with the wire loops 108 and/or the tag devices 114. The main controller 116 can serve as a livestock data and management system (sometimes referred to herein as a “data silo”) for managing one or more livestock animals 102 and/or one or more feedlots 104. In some embodiments, the main controller 116 may be distinct from the respective base stations 106 yet communicatively coupled or linked thereto (e.g., via a wired or wireless network connection). In some embodiments, however, the main controller 116 and one of the base stations 106 may be part of a single interface unit (e.g., housed and/or directly coupled (e.g., hard-wired) together). In this latter scenario, it is to be understood that there may be a single combined main controller 116 and base station 106 unit and multiple satellite base stations 106. The main controller 116 can include, for example, a main processor 118, a main communications interface 120 (e.g., a transceiver unit), and a main memory 122.

In some embodiments, the main controller 116 can be considered to be a data silo and can generally include an ability to monitor the living patterns (e.g., movement, eating, drinking) of a herd of livestock, livestock groups (e.g., age, sex, breed), and/or individual animals, may provide insight into the health and/or well-being of such animals, and may help in managing provision (e.g., feed, water) availability (e.g., favorite feeding times may change; more water may be needed at peak times; etc.). The main controller 116 can include a transceiver (e.g., implemented using the main communications interface 120), a main memory 122, and a main processor 118. The transceiver is configured to receive a historical data set pertaining to a livestock animal 102 from a base station 106. The base station 106 is in communication with a plurality of tag devices 114 including a respective tag device 114 attached to the corresponding livestock animal 102. The tag device 114, in turn, is configured to periodically transmit information to the base station 106 including the historical data set pertaining to the livestock animal 102. One or more of the base stations 106 and/or the main processor 118 (i.e., the data silo) may, for example, upload information from the respective tag devices 114 every 24 hours or every 48 hours or more often, particularly if a livestock animal 102 has been noted by the system as a “watch” animal (i.e., deemed to need closer attention). Likewise, the one or more of the base stations 106 and/or the main processor 118 (i.e., the data silo) may, for example, download information to the respective tag devices 114 when available or on a set cadence (e.g., weekly).

The historical data set includes data regarding a proximity of the livestock animal 102 to at least one wire loop 108 that is associated with a respective feed lot feature 124. The main memory 122 is configured to store the historical data set pertaining to the livestock animal 102. The main processor 118 is configured to analyze the historical data set pertaining to the livestock animal 102 to determine whether livestock animal 102 exhibits a behavioral anomaly associated with a predetermined intervention. If, for example, the main processor 118 decides that a livestock animal 102 may be sick and/or in need of further evaluation, the main processor 118, via its main communications interface 120, can send a signal (e.g., directly or indirectly via one or more base stations 106) to the corresponding tag device 114 of the respective livestock animal 102 to light up (e.g., as discussed later) the tag device 114 and/or may generate instructions (e.g., in form of a document to be displayed, saved, e-mailed, and/or printed) for treatment of the livestock animal 102.

In some embodiments, the main processor 118 of the data silo (i.e., main controller 116) is further configured to transmit, via the main communications interface 120 (i.e., the transceiver), an instruction for the tag device 114 associated with the livestock animal 102 to indicate the intervention. The data silo may further include a network connector (e.g., as furnished by the main communications interface 120) configured to furnish internet access to or from the data silo. The main memory 122 can, for example, be in the form of a database server memory or a cloud computing memory.

The historical data set for a given livestock animal 102 can include various forms, all of which can be stored in the main memory 122 of the data silo. The historical data generated from the feedlot 104 via wire loops 108 associated with respective feed lot features 124 can include information regarding the passage of the livestock animal 102 through particular gates, feeding times and length of times feeding (e.g., the latter being co-relatable to food consumption), watering times and length of times drinking (e.g., the latter being co-relatable to water consumption), and favorite places to feed and/or drink (if not specifically controlled). In some embodiments, the plurality of historical data sets includes data regarding proximities of the livestock animals 102 to one or more wire loops 108 that are associated with respective feed lot features 124. The historical data can further include other known data (e.g., veterinary records) about a respective livestock animal 102 which was not necessarily generated at the feedlot 104.

The main memory 122 can be configured to store the plurality of historical data sets, while the main processor 118 can be configured to analyze the plurality of historical data sets to determine individual and/or herd behavior of the livestock animals 102 being monitored. In some embodiments, the processor is configured to analyze the historical data set pertaining to the livestock animal 102 by comparing the historical data set pertaining to a respective livestock animal 102 and the plurality of historical data sets pertaining to the livestock animals 102 (e.g., compare individuals to overall herd or to a population segment (e.g., age group; sex; etc.)). The processor may be configured to use the historical data to determine whether a respective one or more of the livestock animals exhibits a behavioral anomaly, which may be associated with a predetermined intervention. An intervention may be, for example, the need to administer veterinary care and/or a change (e.g., volume and/or timing) in the provision of food and/or water. In some embodiments, the processor is further configured to transmit, via the transceiver, an instruction for a tag device 114 to store a filtered subset of the historical data set associated with the livestock animal 102 corresponding to the respective tag device 114.

The base station 106, in one embodiment, is configured for bidirectional communications with a plurality of mobile communication units, which in the illustrated embodiments, are shown as mobile tag devices 114 (e.g., being made mobile by being carried by a corresponding livestock animal 102). Such mobile communication units or tag devices 114 are configured to serve as transceivers, as detailed later in the application. The base station can include a radio frequency receiver 126 (e.g., a high-gain directional antenna), a radio frequency transmitter 128, and a base controller 130. The base controller 130 can, in turn, include a base processor 132, a base communications interface 134, and a base memory 136. The base communications interface 134 can be configured for communicating information between (e.g., received from and/or transmitted to) the base controller and the plurality of mobile tag devices 114. The base communications interface 134 may be, for example, a wireless computer networking interface or a mobile communications device interface. The base station 106 may further incorporate one or more environmental sensors 138 (e.g., temperature, humidity, position), in operative communication with the base controller 130. Such environmental sensors 138 can be used to provide environmental information about an area or space occupied by the respective base station 106 with which they are associated. Additionally, the base station 106 may be provided with one or more universal serial bus (USB) ports or other known data transfer ports (not shown).

The radio frequency receiver 126 can be configured to receive transmissions from the plurality of mobile tag devices 114 within a plurality of timed reception slots, each one of the plurality of timed reception slots being assignable to one of the plurality of mobile tag devices 114. The radio frequency transmitter 128 can be configured to broadcast an intermittent beacon signal to the plurality of mobile tag devices 114 within a timed transmission slot, the intermittent beacon signal indicating timing of the timed transmission slot, timing of the plurality of timed reception slots, identifications of individual ones of the plurality of timed reception slots assigned to individual ones of the plurality of mobile tag devices 114, and identifications of individual ones of the plurality of timed reception slots that are unassigned. The base controller 130 can be configured to analyze transmissions received from the plurality of mobile tag devices 114 within the plurality of timed reception slots to identify a transmission from an unassigned mobile tag device 114 of the plurality of mobile tag devices 114 received during an unassigned reception slot of the plurality of timed reception slots and assign the unassigned reception slot to the unassigned mobile tag device 114.

A low-frequency emitting system 112 for identifying a feed lot feature 124, per above, can include at least one wire loop 108 and a respective wire driver 110. A respective wire loop 108 is physically associated with (e.g., encircling, surrounding, or coextending) or positioned adjacent to the corresponding feed lot feature 124. The wire loop 108 may, for example, be formed of a wire of between about twelve (12) American wire gauge and about thirty (30) American wire gauge, e.g., between about fourteen (14) American wire gauge (AWG) and about twenty (20) American wire gauge. The wire loop 108 further may include a boundary wire of any length, as needed for a given feedlot feature 124. In some embodiments, the boundary wire may be five feet in length or more, such as five thousand feet in length. In some embodiments, the boundary wire may be less than five feet in length (e.g., having a zero (external) length loop, a one-inch internal length loop, etc.). For example, a shorter length wire may be used as a point source feature marker.

In some embodiments, the wire driver 110 is coupled to the at least one wire loop 108 and includes a low frequency transmitter or transceiver (not shown) configured to transmit or otherwise drive a low frequency signal 140 (e.g., up to 50 kHz (kilohertz); or in a range of 3-30 kHz) via/through the at least one wire loop 108. For example, the wire driver 110 may generate a low frequency (e.g., VLF) signal through a plurality of wire loops 108. In some embodiments, the wire driver 110 is configured to drive a response through a corresponding wire loop 108 when queried by a transceiver of the plurality of mobile tag devices 114. The wire driver 110 may use a low voltage of between about one volt (1 V) and twenty-four volts (24 V), e.g., between about three volts (3 V) and about fifteen volts (15 V), within the one or more wire loops 108 with which it is associated to create the desired low frequency signal 140.

The base controller 130 can be configured to communicate with the wire driver 110. The intermittent beacon signal generated by the radio frequency transmitter 128 of the respective base station 106 includes a radio frequency signal having a substantially higher frequency than the low frequency signal 140 (e.g., a very low frequency signal) driven through the wire loop 108. In one example, the substantially higher frequency comprises a frequency of about two and four-tenths gigahertz (2.4 GHz). In some embodiments, the low frequency signal 140 is asynchronous relative to the signals used for base station communications (e.g., helping to avoid communication interference). The wire driver 110 may further include a driver communications interface 142 configured to communicate with the tag device 114 utilizing high frequency communication signals (e.g., in the range of 1 GHz (gigahertz) to 10 GHz), the high frequency communications signals having a higher frequency than the low frequency signal 140. The wire driver 110 can be configured to periodically transmit the high frequency communication signal that identifies the wire driver 110 to the tag device 114. In some embodiments, one or more wire drivers 110 may be incorporated as part of a given base station 106 (e.g., a base station 106 proximate to a water source and/or a feed trough, facilitating consolidation of such units). In some embodiments, one or more wire drivers 110 may be communicatively coupled (e.g., wirelessly) with a given base station 106.

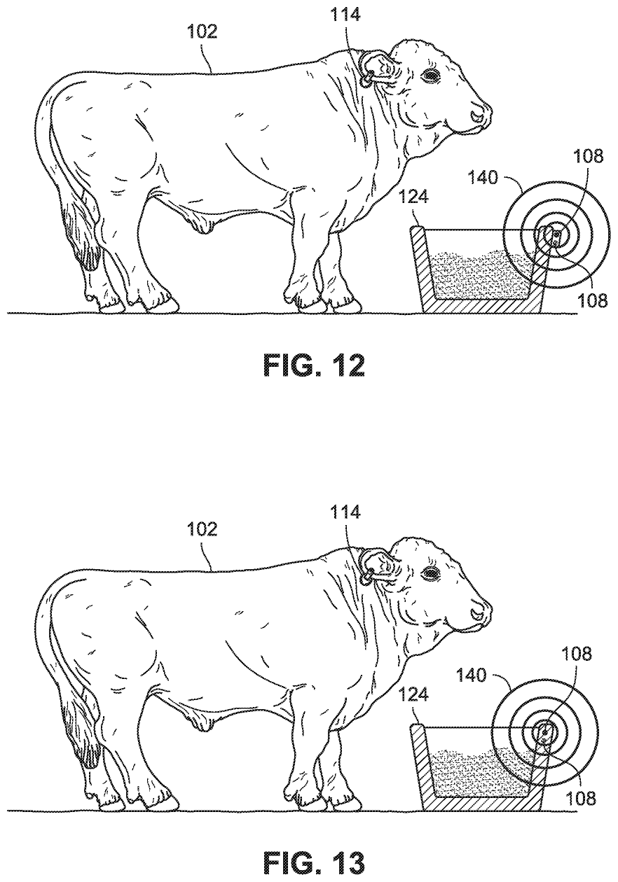

As described with reference to FIG. 12, a wire loop 108 can be fastened (e.g., clipped, stapled, screwed, etc.) to a feedlot feature 124. With reference to FIG. 13, a wire loop 108 can be integrally formed with a feedlot feature (e.g., included as part of a mold, a pour, etc.). In some embodiments, a single wire loop 108 may be used to register two or more separate feedlot features 124 simultaneously (e.g., extending along multiple feed bunks). Further, a wire loop 108 (e.g., a smaller area loop) may be deployed along one feedlot feature 124 (e.g., a single bunk line). It is noted that field strength measurements from the outwardly deployed wire segment of a wire loop 108 may be at least substantially the same as field strength measurements from the return wire of the wire loop 108 (e.g., differing only in a non-distinguished reverse polarity), and the relative deployment geometry of the wire segments may be chosen accordingly. For example, a sensing result may be greater (e.g., maximized) when sensing is performed orthogonal to a deployment plane of the outward and return wire segments, while a sensing result may be lesser (e.g., minimized) when sensing is performed parallel to the deployment plane of the outward and return wire segments.

In some embodiments, the wire driver 110 can facilitate high frequency communications, in addition to aiding in the generation of its respective low frequency signal 140. The wire driver 110 can, for example, be configured to transmit a high frequency communication signal that identifies the wire driver 110 to the tag device 114 via the driver communications interface 142. The wire driver 110 may be configured to transmit the high frequency communication signal that identifies the wire driver 110 to the tag device 114 in response to receiving an interrogation signal from the tag device 114 via the driver communications interface 142. The high frequency communication signal that identifies the wire driver 110 to the tag device 114 can include identification information for the wire driver 110 and frequency band information associated with the low frequency signal 140. The driver communications interface 142 can have a respective antenna capability (e.g., via a built-in or separate antenna (not shown)). The driver communications interface 142 can, alternatively or additionally, be configured to transmit the high frequency communications signals via the wire loop 108 associated therewith.

The length of a given wire loop 108 can vary, in part, based on the size of the feedlot feature 124 that it is associated with. For example, a wire loop 108 physically arranged proximate to a food trough may be longer. However, a wire loop 108 mounted in conjunction with a water source (e.g., a water trough or bin) may be shorter than one accompanying a food trough. A wire loop 108 at a gate may be even shorter.

In some embodiments, the tag device 114 for placement on a livestock animal 102 can generally include a first communications interface 144, a second communications interface 146, one or more batteries 148, a local controller 150, and a carrier structure 152 (e.g., a physical ear tag element). The first communications interface 144 is configured to detect a low frequency signal (e.g., 3-30 kHz (i.e., a very low frequency (VLF) band) or 5-15 kHz) transmitted via at least one wire loop 108, with the at least one wire loop 108 being physically associated with or positioned adjacent to a feed lot feature 124 (e.g., a gate, a water source, a feed trough/food bunk, a geographic location marker, such as a pole, etc.). The second communications interface 146 is configured to communicate with at least one base station 106 utilizing high frequency communication signals (e.g., range of 1 GHz to 10 GHz), where the high frequency communications signals have a higher frequency than the low frequency signal. The one or more batteries 148 are configured to power the first communications interface 144, the second communications interface 146, and the local controller 150. The local controller 150 is coupled to the first communications interface 144, the second communications interface 146, and the one or more batteries 148.

The local controller 150 can be configured to periodically activate the first communications interface 144; detect proximity of the tag device 114 to the at least one wire loop 108 when the first communications interface 144 is active, based on detecting the low frequency signal via the first communications interface 144; and transmit one or more communication signals to the at least one base station 106 during an assigned time slot via the second communications interface 146. The one or more communication signals can include information associated with detecting the proximity of the tag device 114 to the at least one wire loop 108. The carrier structure 152 can be configured to carry the first communications interface 144, the second communications interface 146, the one or more batteries 148, and the local controller 150 and to serve as a mechanism by which the tag device 114 can be carried by the livestock animal 102 (e.g., ear clip; implantable device; animal collar). The tag device 114, overall, can be relatively inexpensive to produce.

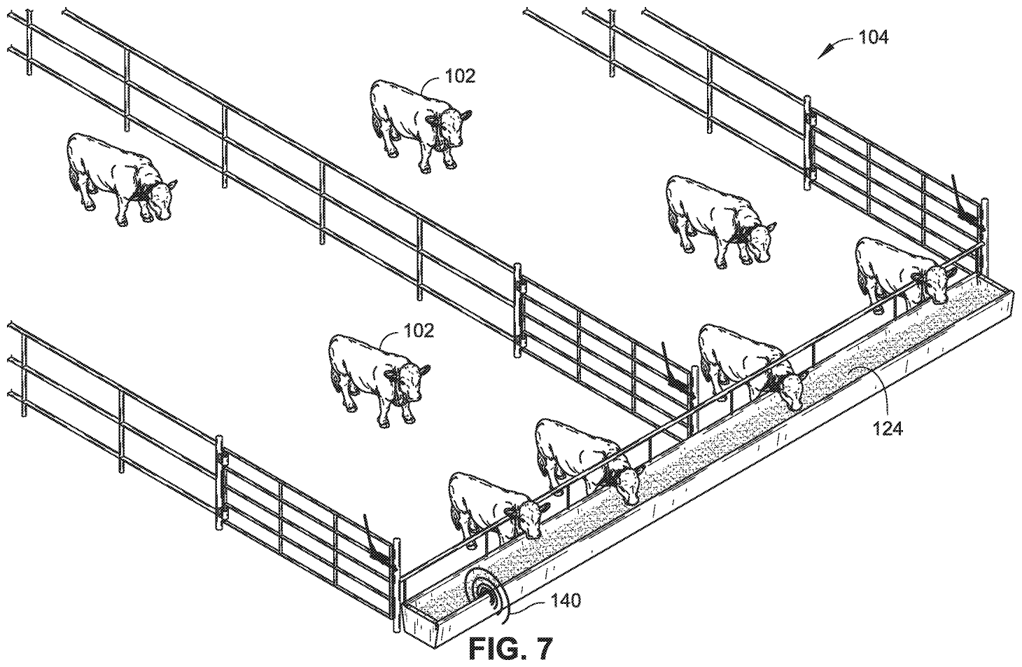

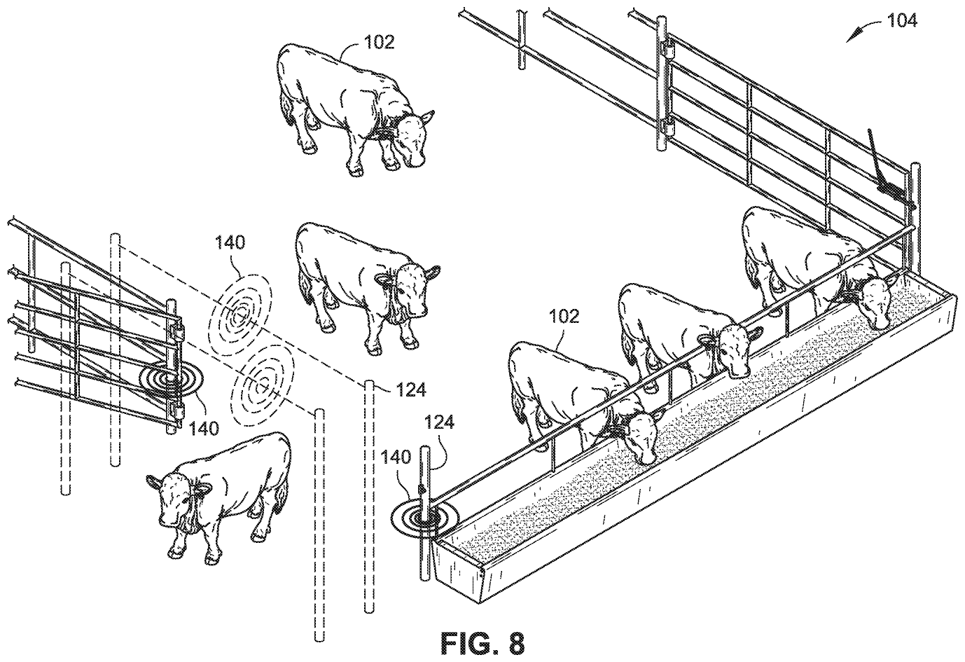

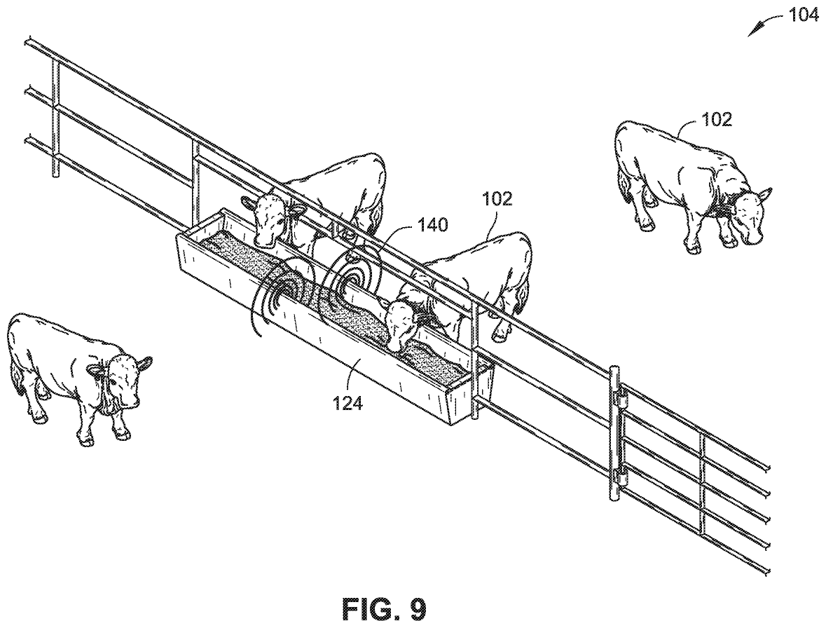

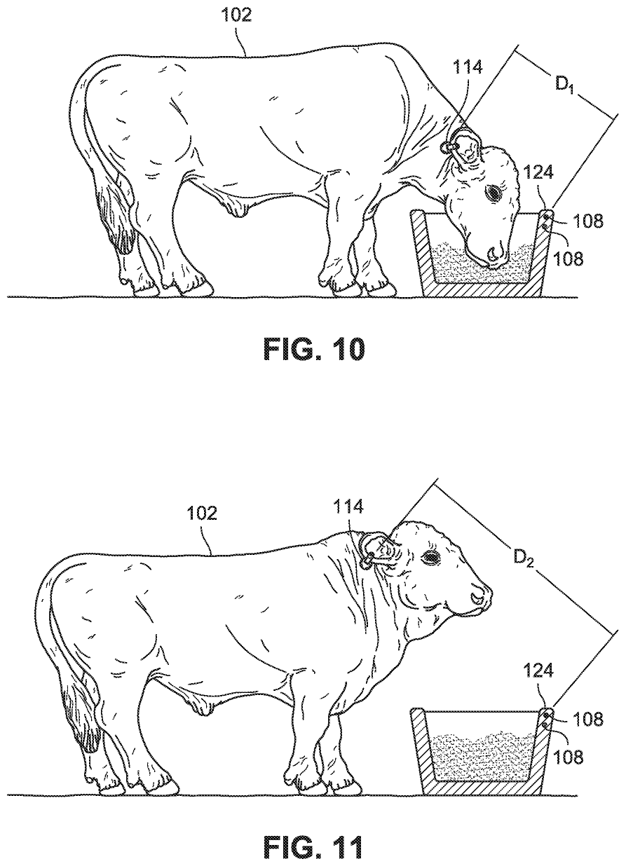

In some embodiments, the first communications interface 144 includes an antenna 154 with a communications link 156 (e.g., in the form of a receiver or transceiver) coupled to the antenna 154. In some embodiments, the antenna 154 can have a detection limit of three to four feet from a given wire loop 108 (e.g., little or no signal detected at a distance D₂ of four or more feet from the closest wire loop 108 as described with reference to FIG. 11), in part, because it is designed to detect a low frequency signal 140 generated by a given wire loop 108. It is noted that, by only detecting a signal at such a short range (e.g., distance D₁ as described with reference to FIG. 10), an active detection of a signal by a respective tag device 114 can be used to confirm that a livestock animal 102 is close enough to a feed lot feature 124 to be passing by it (e.g., proximate to one or more sides of a gate as described with reference to FIG. 8) or likely to be engaged in eating or drinking (e.g., at a feed trough as described with reference to FIG. 7 and/or a water source as described with reference to FIG. 9) based on the length of time located thereat. In some embodiments, the antenna 154 of the first communications interface 144 can be configured to sense a magnetic portion of the low frequency electromagnetic signal 140 generated by a given wire loop 108. For example, low frequency energy can be applied to and taken out of the local magnetic field around the wire that makes up the loop (e.g., oscillating the local magnetic field). Receive coils in the antenna 154 can directly couple to this field, e.g., in the manner of an air-core transformer. In some embodiments, no travelling radio waves (or at least substantially no travelling radio waves) are generated by the signal applied to the wire loop 108 such that the active detection range may be specifically tailored (e.g., controlled) to an area of interest (e.g., a location or a specific geographic area).

In some embodiments, the tracking system 100 may be used to determine a travel direction for a particular livestock animal 102. For example, as described with reference to FIG. 8, multiple (e.g., two, more than two) wire loops 108 may be positioned proximate to (e.g., on, beside, above, below, etc.) various feedlot features 124, such as the gate, and locations determined by the mobile transceiver 114 may be used to determine a relative direction traveled by the livestock animal 102 when moving proximate to (e.g., near, around, through) the feedlot feature 124. For instance, the order (e.g., time-based order) in which low frequency signals 140 associated with multiple wire loops 108 are detected by a mobile transceiver 114 can indicate a direction a livestock animal 102 is travelling, e.g., when each wire loop 108 is transmitting a different low frequency signal 140 associated with a unique location for that wire loop 108.

The local controller 150 can be programmed or otherwise configured to adapt its rate at which it samples for a respective low frequency signal 140. For example, if no feed lot feature 124 is found to be within four feet of the respective livestock animal 102 (i.e., no low frequency signal 140 is detectable by the first communications interface 144), then the sampling rate may remain at a baseline sampling rate (e.g., a two minute interval). However, if a low frequency signal 140 is registered by the antenna 154 of a respective tag device 114, then the sampling rate may be increased (e.g., chosen sampling intervals reduced to times in the range of 1-30 seconds). Increasing the sampling rate can, for example, allow for better precision of the timing measurements at a particular feed lot feature 124 (e.g., length of time eating or drinking).

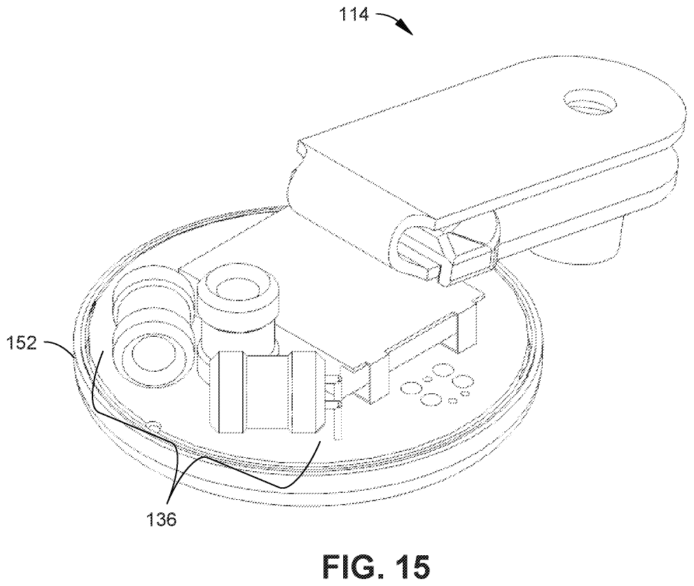

The antenna 154 may be in the form of a multi-axis antenna and, when used in conjunction with the local controller 150, may be configured to ascertain a location of the tag device 114 and the livestock animal 102 carrying it relative to a given wire loop 108. The local controller 150 of a tag device 114 can be configured to determine a signal strength of the low frequency signal 140 based upon a vectorized sum of a detected first axis signal response, a detected second axis signal response, and a detected third axis signal response. The signal strength can be associated with the proximity of the tag device 114 to the at least one wire loop 108. For example, the vector sum of the perceived low frequency energies for each axis can be processed mathematically to arrive at a radial measure of distance from a signal wire (e.g., independent of rotation of the tag device 114 with respect to the wire). In some embodiments, e.g., where distances from multiple wire loops 108 may be determined by simultaneous ranging, triangulation may be used to determine an improved (e.g., more accurate) location for a tag device 114. Further, triangulation may be employed using received signal strength indicator (RSSI) measurements that accompany high frequency (radio) transactions between various components of the tracking system 100 (e.g., including tag devices 114, base stations 106, wire drivers 110, etc.) as an independent positional measurement. In some embodiments, the antenna 154 may be in the form of a wire loop antenna, and, where a multi-axis version is employed, the antenna 154 may incorporate three coils (e.g., as described with reference to FIG. 15). However, it should be noted that three coils are provided by way of example only and are not meant to limit the present disclosure. In other embodiments, more than three (e.g., four, five, etc.) or less than three (e.g., two, one) coils may be used to determine a signal strength for the low frequency signal 140. For example, more than three coils may be used to provide redundancy, simultaneity of frequency distinct measurements, and so forth.

The local controller 150 can, in some embodiments, be further configured to activate the second communications interface 146 to initiate communications with the at least one base station 106 during the assigned time slot when the signal strength is indicative of the proximity of the tag device 114 to the at least one wire loop 108 being within a threshold proximity. The local controller 150 of the tag device 114 may be configured to store a data entry associated with the proximity of the antenna 154 of the first communications interface 144 to the at least one wire loop 108 when the proximity of the tag device 114 to the at least one wire loop 108 is within a threshold proximity (e.g., within a range of 10 feet, 5 feet, 4 feet, 3 feet, 2 feet, 1 foot, etc., from the wire loop 108). A respective wire loop 108 may transmit at a particular wavelength and/or generate a secondary signal as a means of creating a wire address (e.g., a wire identifier, permitting its location and/or feed lot feature 124 type to be known), and, in turn, the local controller 150 of the tag device 114 may be configured to identify and/or register such a wire address. In some embodiments, the second communications interface 146 can incorporate a high frequency antenna (e.g., a 2.4 GHz ¼ wave dipole antenna) (not separately shown) to aid in communication with, e.g., a respective base station 106.

The local controller 150 of the tag device 114 can be configured to determine the assigned time slot by: receiving a communication signal from the at least one base station 106 that identifies a plurality of unassigned time slots and a plurality of assigned time slots; transmitting information to the at least one base station 106 during a time slot of the plurality of unassigned time slots, and receiving a second communication signal from the at least one base station 106. The second communication signal is identifiable with the time slot as the assigned time slot for the tag device 114.

The tag device 114 can, in some embodiments, include a local memory 158. The local memory 158 may be included within or coupled to the local controller 150. Further, the local controller 150 can be configured to store a data entry associated with detecting the proximity of the tag device 114 to the at least one wire loop 108 in the local memory. The data entry may include, for example, a time stamp, a feed lot location (e.g., particular feed trough, water source, gate, etc.), and/or a length of time at a location. The data stored in a local memory 158 may be accessed, for example, via a wireless or wired connection and may be collected, e.g., on a particular schedule or as desired. For example, the data may be frequently off-loaded (e.g., hourly or daily) to one or more base stations 106. The local memory 158 may further be able to store historical and/or medical (e.g., veterinary) data about a respective livestock animal 102, in addition to the tracking data being generated. The local memory 158 and the local controller 150 together can serve as a mechanism to read/receive and write/transmit information related to the livestock animal 102. Additionally, the local memory 158 may be cleared, if desired, to permit, e.g., the tag device 114 to be transferred to another livestock animal 102 for reuse of the tag device 114.

The local controller 150 of the tag device 114 can be provided with additional management features. For example, the local controller 150 may be configured, programmed, or otherwise provided with an internal clock that can be synchronized with the operation of the one or more base stations 106. In such a manner, clock management of the various tag devices 114 may be harmonized across the tracking system 100. The local controller 150 may also be configured to manage battery usage, in part, to extend the life of the one or more batteries 148 associated with the tag device 114. Such battery management can involve the control of the time for receiving and/or transmitting signals and the length of time for sleep periods (e.g., down time length, during which no signals are received and/or transmitted, thereby minimizing battery drain). For example, the actual time needed to take a sample may be quite short (e.g., on the order of 10 milliseconds or less; or possibly 5 milliseconds or less). The short sampling time can facilitate greater “sleep” periods (i.e., low-power consumption), even when sample intervals are on the order of seconds. In some embodiments, the battery management system can be configured to have the local controller 150 in sleep mode over 95% of the time or over 99% of the time. The local controller 150 may be equipped with an accelerometer (not shown), either as a built-in feature or as a separate component, to aid in tracking movement of the livestock animal 102 corresponding to the respective tag device 114.

A given tag device 114 may further include one or more indicators (e.g., indicator lights 160, such as light emitting diodes (LEDs) and/or other visual indicators) coupled to the local controller 150 thereof. The local controller 150 can be configured to activate the one or more indicator lights 160 in response to detecting at least one predefined event. The predefined event includes at least one of: a detected low battery level, a received request from the at least one base station 106, an error event, or a detected non-normative behavior of the livestock animal 102 that is determined based on stored data entries. The predefined event, for example, may include one or more of: a detected low battery level, a received request from the at least one base station 106, an error event, or a detected non-normative behavior or behavioral anomaly of the livestock animal 102 that is determined based on stored data entries. The chosen lighting characteristics (e.g., number and/or pattern of lights; color of lights; etc.) may be used convey specific information.

The second communications interface 146, in some embodiments, of a given tag device 114 may be configured to communicate with at least one base station 106 utilizing high frequency communication signals, with the high frequency communications signals having a higher frequency (e.g., 1 GHz to 10 GHz) than the low frequency signal 140. The second communications interface 146 may also be configured to communicate using digital signals. The second communications interface 146 may be able to send and/or receive signals over longer distances (e.g., five feet or more; several yards) than the detection length for the first communications interface 144. That is, the first communications interface 144 is designed and configured to facilitate communication between the tag device 114 and a suitably proximate wire loop 108, at least in a low frequency range, while the second communications interface 146 is configured to communicate with devices other than the one or more wire loops 108 and/or their related wire drivers 110, e.g., with one or more base stations 106.

A method for bidirectionally communicating with a plurality of mobile transceivers (e.g., mobile tag devices 114) is available for use via the one or more base stations 106. Transmissions are received from the plurality of mobile transceivers within a plurality of timed reception slots, each one of the plurality of timed reception slots assignable to one of the plurality of mobile transceivers. An intermittent beacon signal is broadcast to the plurality of mobile transceivers within a timed transmission slot, with the intermittent beacon signal indicating timing of the timed transmission slot, timing of the plurality of timed reception slots, identifications of individual ones of the plurality of timed reception slots assigned to individual ones of the plurality of mobile transceivers, and identifications of individual ones of the plurality of timed reception slots that are unassigned. Transmissions received from the plurality of mobile transceivers within the plurality of timed reception slots are analyzed to identify a transmission from an unassigned mobile transceiver of the plurality of mobile transceivers received during an unassigned reception slot of the plurality of timed reception slots and to assign the unassigned reception slot to the unassigned mobile transceiver.

The tracking system 100, including some or all of its components, can operate under computer control. For example, base stations 106, wire drivers 110, tag devices 114, and the main controller 116 (i.e., the data silo) include respective controllers (e.g., local controller 150, base controller 130, main processor 118, and so forth). In embodiments, a controller can include a processor, a memory, and a communications interface. The processor provides processing functionality for at least the controller and can include any number of processors, micro-controllers, circuitry, field programmable gate array (FPGA) or other processing systems, and resident or external memory for storing data, executable code, and other information accessed or generated by the controller. The processor can execute one or more software programs embodied in a non-transitory computer readable medium that implement techniques described herein. The processor is not limited by the materials from which it is formed or the processing mechanisms employed therein and, as such, can be implemented via semiconductor(s) and/or transistors (e.g., using electronic integrated circuit (IC) components), and so forth.

The memory can be an example of tangible, computer-readable storage medium that provides storage functionality to store various data and or program code associated with operation of the controller, such as software programs and/or code segments, or other data to instruct the processor, and possibly other components of the tracking system 100, to perform the functionality described herein. Thus, the memory can store data, such as a program of instructions for operating the tracking system 100 (including its components), and so forth. It should be noted that while a single memory is described, a wide variety of types and combinations of memory (e.g., tangible, non-transitory memory) can be employed. The memory can be integral with the processor, can comprise stand-alone memory, or can be a combination of both.

Some examples of the memory can include removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, remove (e.g., server and/or cloud) memory, and so forth. In implementations, memory can include removable integrated circuit card (ICC) memory, such as memory provided by a subscriber identity module (SIM) card, a universal subscriber identity module (USIM) card, a universal integrated circuit card (UICC), and so on.

The communications interface can be operatively configured to communicate with components of the tracking system 100. For example, the communications interface can be configured to transmit data for storage by the tracking system 100, retrieve data from storage in the tracking system 100, and so forth. The communications interface can also be communicatively coupled with the processor to facilitate data transfer between components of the tracking system 100 and the processor. It should be noted that while the communications interface is described as a component of controller, one or more components of the communications interface can be implemented as external components communicatively coupled to the tracking system 100 or components thereof via a wired and/or wireless connection. The tracking system 100 or components thereof can also include and/or connect to one or more input/output (I/O) devices (e.g., via the communications interface), such as a display, a mouse, a touchpad, a touchscreen, a keyboard, a microphone (e.g., for voice commands) and so on.

The communications interface and/or the processor can be configured to communicate with a variety of different networks, such as a wide-area cellular telephone network, such as a cellular network, a 3G cellular network, a 4G cellular network, or a global system for mobile communications (GSM) network; a wireless computer communications network, such as a WiFi network (e.g., a wireless local area network (WLAN) operated using IEEE 802.11 network standards); an ad-hoc wireless network, an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface can be configured to communicate with a single network or multiple networks across different access points. In a specific embodiment, a communications interface can transmit information from the controller to an external device (e.g., a cell phone, a computer connected to a WiFi network, cloud storage, etc.). In another specific embodiment, a communications interface can receive information from an external device (e.g., a cell phone, a computer connected to a WiFi network, cloud storage, etc.).

Example embodiments in accordance with the present disclosure include the following combinations of elements:

1. A system for monitoring livestock behavior, the system comprising:

a wire loop to be physically associated with at least one feedlot feature, the feedlot feature capable of a behavioral interaction by the livestock;

a wire driver for driving a very low frequency (VLF) radio signal through the wire loop;

a plurality of mobile transceivers, each one of the plurality of mobile transceivers capable of being worn by the livestock and including:
at least one wire coil configured for a magnetic coupling with the wire loop by the very low frequency radio signal when sufficiently close to the wire loop,
circuitry for determining a magnetic field strength when magnetically coupled with the wire loop, and
a processor for determining when to report a proximity to the wire loop based upon the determined magnetic field strength;

a base station configured for bidirectional communications with the plurality of mobile transceivers and including at least one of a wireless computer networking interface or a mobile communications device interface for communicating information received from the plurality of mobile transceivers.

2. The system as recited in claim 1, wherein the feedlot feature comprises at least one of a feed trough, a water feature, or a gate.

3. The system as recited in claim 1, wherein the at least one wire coil comprises three (3) wire coils positioned at least substantially orthogonal to one another.

4. The system as recited in claim 1, wherein the base station comprises a radio frequency receiver configured to receive transmissions from the plurality of mobile transceivers within a plurality of timed reception slots, each one of the plurality of timed reception slots assignable to one of the plurality of mobile transceivers.

5. The system as recited in claim 4, wherein the base station comprises a radio frequency transmitter configured to broadcast an intermittent beacon signal to the plurality of mobile transceivers within a timed transmission slot, the intermittent beacon signal indicating timing of the timed transmission slot, timing of the plurality of timed reception slots, identifications of individual ones of the plurality of timed reception slots assigned to individual ones of the plurality of mobile transceivers, and identifications of individual ones of the plurality of timed reception slots that are unassigned; and a controller configured to analyze transmissions received from the plurality of mobile transceivers within the plurality of timed reception slots to identify a transmission from an unassigned mobile transceiver of the plurality of mobile transceivers received during an unassigned reception slot of the plurality of timed reception slots and assign the unassigned reception slot to the unassigned mobile transceiver.

6. The system as recited in claim 5, wherein the intermittent beacon signal comprises a radio frequency signal having a substantially higher frequency than the very low frequency radio signal driven through the wire loop.

7. The system as recited in claim 6, wherein the substantially higher frequency comprises a frequency of about two and four-tenths gigahertz (2.4 GHz).

8. The system as recited in claim 1, wherein the very low frequency radio signal comprises a frequency of between about five kilohertz (5 kHz) and about fifteen kilohertz (15 kHz).

9. The system as recited in claim 1, wherein the wire driver drives the very low frequency radio signal at a low voltage of between about three volts (3 V) and about fifteen volts (15 V).

10. The system as recited in claim 1, wherein the wire loop comprises a wire of between about fourteen (14) American wire gauge (AWG) and about twenty (20) American wire gauge.

11. The system as recited in claim 1, wherein the wire loop comprises a boundary wire at least five feet in length.

12. The system as recited in claim 1, wherein the wire driver is configured to drive a plurality of very low frequency radio signals through a plurality of wire loops.

13. The system as recited in claim 1, wherein the wire driver is configured to drive a response through the wire loop when queried by a transceiver of the plurality of mobile transceivers.

14. The system as recited in claim 13, wherein the response comprises a frequency of about two and four-tenths gigahertz (2.4 GHz).

15. The system as recited in claim 1, wherein the plurality of mobile transceivers comprises a plurality of cattle ear tags.

16. The system as recited in claim 1, wherein the base station further comprises at least one of a temperature sensor, a humidity sensor, or a position sensor for determining environmental information about an area occupied by the base station.

17. A method for monitoring livestock behavior, the method comprising:

physically associating a wire loop with at least one feedlot feature, the feedlot feature capable of a behavioral interaction by the livestock;

driving a very low frequency (VLF) radio signal through the wire loop;

receiving transmissions from a plurality of mobile transceivers, each one of the plurality of mobile transceivers capable of being worn by the livestock and including:
at least one wire coil configured for a magnetic coupling with the wire loop by the very low frequency radio signal when sufficiently close to the wire loop,
circuitry for determining a magnetic field strength when magnetically coupled with the wire loop, and
a processor for determining when to report a proximity to the wire loop based upon the determined magnetic field strength; and

bidirectionally communicating with the plurality of mobile transceivers and communicating information received from the plurality of mobile transceivers through at least one of a wireless computer networking interface or a mobile communications device interface.

18. The method as recited in claim 17, wherein the feedlot feature comprises at least one of a feed trough, a water feature, or a gate.

19. The method as recited in claim 17, wherein the at least one wire coil comprises three (3) wire coils positioned at least substantially orthogonal to one another.

20. The method as recited in claim 17, further comprising receiving transmissions from the plurality of mobile transceivers within a plurality of timed reception slots, each one of the plurality of timed reception slots assignable to one of the plurality of mobile transceivers.

21. The method as recited in claim 20, further comprising broadcasting an intermittent beacon signal to the plurality of mobile transceivers within a timed transmission slot, the intermittent beacon signal indicating timing of the timed transmission slot, timing of the plurality of timed reception slots, identifications of individual ones of the plurality of timed reception slots assigned to individual ones of the plurality of mobile transceivers, and identifications of individual ones of the plurality of timed reception slots that are unassigned; and analyzing transmissions received from the plurality of mobile transceivers within the plurality of timed reception slots to identify a transmission from an unassigned mobile transceiver of the plurality of mobile transceivers received during an unassigned reception slot of the plurality of timed reception slots and assign the unassigned reception slot to the unassigned mobile transceiver.

22. The method as recited in claim 21, wherein the intermittent beacon signal comprises a radio frequency signal having a substantially higher frequency than the very low frequency radio signal driven through the wire loop.

23. The method as recited in claim 22, wherein the substantially higher frequency comprises a frequency of about two and four-tenths gigahertz (2.4 GHz).

24. The method as recited in claim 17, wherein the very low frequency radio signal comprises a frequency of between about five kilohertz (5 kHz) and about fifteen kilohertz (15 kHz).

25. The method as recited in claim 17, wherein the very low frequency radio signal is driven at a low voltage of between about three volts (3 V) and about fifteen volts (15 V).

26. The method as recited in claim 17, wherein the wire loop comprises a wire of between about fourteen (14) American wire gauge (AWG) and about twenty (20) American wire gauge.

27. The method as recited in claim 17, wherein the wire loop comprises a boundary wire at least five feet in length.

28. The method as recited in claim 17, wherein the very low frequency radio signal and at least a second very low frequency radio signal are driven through a plurality of wire loops.

29. The method as recited in claim 17, further comprising driving a response through the wire loop when queried by a transceiver of the plurality of mobile transceivers.

30. The method as recited in claim 29, wherein the response comprises a frequency of about two and four-tenths gigahertz (2.4 GHz).

31. The method as recited in claim 17, wherein the plurality of mobile transceivers comprises a plurality of cattle ear tags.

32. The method as recited in claim 17, further comprising determining environmental information including at least one of a temperature, a humidity, or a position.

33. A non-transitory computer-readable storage medium comprising code stored for monitoring livestock behavior, the code comprising:

driving a very low frequency (VLF) radio signal through a wire loop physically associated with at least one feedlot feature, the feedlot feature capable of a behavioral interaction by the livestock;

receiving transmissions from a plurality of mobile transceivers, each one of the plurality of mobile transceivers capable of being worn by the livestock and including:
at least one wire coil configured for a magnetic coupling with the wire loop by the very low frequency radio signal when sufficiently close to the wire loop,
circuitry for determining a magnetic field strength when magnetically coupled with the wire loop, and
a processor for determining when to report a proximity to the wire loop based upon the determined magnetic field strength; and

bidirectionally communicating with the plurality of mobile transceivers and communicating information received from the plurality of mobile transceivers through at least one of a wireless computer networking interface or a mobile communications device interface.

34. The method as recited in claim 33, wherein the feedlot feature comprises at least one of a feed trough, a water feature, or a gate.

35. The method as recited in claim 33, wherein the at least one wire coil comprises three (3) wire coils positioned at least substantially orthogonal to one another.

36. The method as recited in claim 33, further comprising receiving transmissions from the plurality of mobile transceivers within a plurality of timed reception slots, each one of the plurality of timed reception slots assignable to one of the plurality of mobile transceivers.

37. The method as recited in claim 36, further comprising broadcasting an intermittent beacon signal to the plurality of mobile transceivers within a timed transmission slot, the intermittent beacon signal indicating timing of the timed transmission slot, timing of the plurality of timed reception slots, identifications of individual ones of the plurality of timed reception slots assigned to individual ones of the plurality of mobile transceivers, and identifications of individual ones of the plurality of timed reception slots that are unassigned; and analyzing transmissions received from the plurality of mobile transceivers within the plurality of timed reception slots to identify a transmission from an unassigned mobile transceiver of the plurality of mobile transceivers received during an unassigned reception slot of the plurality of timed reception slots and assign the unassigned reception slot to the unassigned mobile transceiver.

38. The method as recited in claim 37, wherein the intermittent beacon signal comprises a radio frequency signal having a substantially higher frequency than the very low frequency radio signal driven through the wire loop.

39. The method as recited in claim 38, wherein the substantially higher frequency comprises a frequency of about two and four-tenths gigahertz (2.4 GHz).

40. The method as recited in claim 33, wherein the very low frequency radio signal comprises a frequency of between about five kilohertz (5 kHz) and about fifteen kilohertz (15 kHz).

41. The method as recited in claim 33, wherein the very low frequency radio signal is driven at a low voltage of between about three volts (3 V) and about fifteen volts (15 V).

42. The method as recited in claim 33, wherein the wire loop comprises a wire of between about fourteen (14) American wire gauge (AWG) and about twenty (20) American wire gauge.

43. The method as recited in claim 33, wherein the wire loop comprises a boundary wire at least five feet in length.

44. The method as recited in claim 33, wherein the very low frequency radio signal and at least a second very low frequency radio signal are driven through a plurality of wire loops.

45. The method as recited in claim 33, further comprising driving a response through the wire loop when queried by a transceiver of the plurality of mobile transceivers.

46. The method as recited in claim 45, wherein the response comprises a frequency of about two and four-tenths gigahertz (2.4 GHz).

47. The method as recited in claim 33, wherein the plurality of mobile transceivers comprises a plurality of cattle ear tags.

48. The method as recited in claim 33, further comprising determining environmental information including at least one of a temperature, a humidity, or a position.

49. A system for establishing and maintaining communications with a multiplicity of mobile transceivers, the system comprising:

a plurality of mobile transceivers, each one of the plurality of mobile transceivers comprising:
a sensor configured to frequently determine characteristic information within an environment proximate to the mobile transceiver,
a limited memory configured to temporarily store the characteristic information, and
a controller configured to transmit the characteristic information from the mobile transceiver; and

a base station configured for bidirectional communications with the plurality of mobile transceivers, the base station comprising:
a radio frequency receiver configured to receive transmissions from the plurality of mobile transceivers within a plurality of timed reception slots, each one of the plurality of timed reception slots assignable to one of the plurality of mobile transceivers,
a radio frequency transmitter configured to broadcast an intermittent beacon signal to the plurality of mobile transceivers within a timed transmission slot, the intermittent beacon signal indicating timing of the timed transmission slot, timing of the plurality of timed reception slots, identifications of individual ones of the plurality of timed reception slots assigned to individual ones of the plurality of mobile transceivers, and identifications of individual ones of the plurality of timed reception slots that are unassigned, and
a controller configured to analyze transmissions received from the plurality of mobile transceivers within the plurality of timed reception slots to identify a transmission from an unassigned mobile transceiver of the plurality of mobile transceivers received during an unassigned reception slot of the plurality of timed reception slots and assign the unassigned reception slot to the unassigned mobile transceiver, wherein the characteristic information from the mobile transceiver can be transmitted from the mobile transceiver to the base station frequently enough to limit an amount of required storage space in the limited memory of the mobile transceiver.

50. The system as recited in claim 49, further comprising a wire driver for driving a very low frequency (VLF) radio signal through a wire loop.

51. The system as recited in claim 50, wherein the intermittent beacon signal comprises a radio frequency signal having a substantially higher frequency than the very low frequency radio signal driven through the wire loop.

52. The system as recited in claim 51, wherein the substantially higher frequency comprises a frequency of about two and four-tenths gigahertz (2.4 GHz).

53. The system as recited in claim 50, wherein the very low frequency radio signal comprises a frequency of between about five kilohertz (5 kHz) and about fifteen kilohertz (15 kHz).

54. The system as recited in claim 50, wherein the wire driver drives the very low frequency radio signal at a low voltage of between about three volts (3 V) and about fifteen volts (15 V).

55. The system as recited in claim 50, wherein the wire loop comprises a wire of between about fourteen (14) American wire gauge (AWG) and about twenty (20) American wire gauge.

56. The system as recited in claim 50, wherein the wire loop comprises a boundary wire at least five feet in length.

57. The system as recited in claim 50, wherein the wire loop is physically associated with at least one feedlot feature.

58. The system as recited in claim 50, wherein the wire driver is configured to drive a plurality of very low frequency radio signals through a plurality of wire loops.

59. The system as recited in claim 50, wherein the wire driver is configured to drive a response through the wire loop when queried by a transceiver of the plurality of mobile transceivers.

60. The system as recited in claim 59, wherein the response comprises a frequency of about two and four-tenths gigahertz (2.4 GHz).

61. The system as recited in claim 49, wherein the radio frequency receiver comprises a high-gain directional antenna.

62. The system as recited in claim 49, wherein the plurality of mobile transceivers comprises a plurality of cattle ear tags.

63. The system as recited in claim 49, further comprising at least one of a wireless computer networking interface or a mobile communications device interface for communicating information received from the plurality of mobile transceivers.

64. The system as recited in claim 49, further comprising at least one of a temperature sensor, a humidity sensor, or a position sensor for determining environmental information about an area occupied by the base station.

65. A method for establishing and maintaining communications with a multiplicity of mobile transceivers, the method comprising:

frequently determining, by a mobile transceiver, characteristic information within an environment proximate to the mobile transceiver;

temporarily storing the characteristic information at the mobile transceiver;

transmitting the characteristic information from the mobile transceiver;

receiving transmissions from the plurality of mobile transceivers within a plurality of timed reception slots, each one of the plurality of timed reception slots assignable to one of the plurality of mobile transceivers;

broadcasting an intermittent beacon signal to the plurality of mobile transceivers within a timed transmission slot, the intermittent beacon signal indicating timing of the timed transmission slot, timing of the plurality of timed reception slots, identifications of individual ones of the plurality of timed reception slots assigned to individual ones of the plurality of mobile transceivers, and identifications of individual ones of the plurality of timed reception slots that are unassigned; and

analyzing transmissions received from the plurality of mobile transceivers within the plurality of timed reception slots to identify a transmission from an unassigned mobile transceiver of the plurality of mobile transceivers received during an unassigned reception slot of the plurality of timed reception slots and assign the unassigned reception slot to the unassigned mobile transceiver,

66. The method as recited in claim 65, further comprising driving a very low frequency (VLF) radio signal through a wire loop.

67. The method as recited in claim 66, wherein the intermittent beacon signal comprises a radio frequency signal having a substantially higher frequency than the very low frequency radio signal driven through the wire loop.

68. The method as recited in claim 67, wherein the substantially higher frequency comprises a frequency of about two and four-tenths gigahertz (2.4 GHz).

69. The method as recited in claim 66, wherein the very low frequency radio signal comprises a frequency of between about five kilohertz (5 kHz) and about fifteen kilohertz (15 kHz).

70. The method as recited in claim 66, wherein the very low frequency radio signal is driven at a low voltage of between about three volts (3 V) and about fifteen volts (15 V).

71. The method as recited in claim 66, wherein the wire loop comprises a wire of between about fourteen (14) American wire gauge (AWG) and about twenty (20) American wire gauge.

72. The method as recited in claim 66, wherein the wire loop comprises a boundary wire at least five feet in length.

73. The method as recited in claim 66, wherein the wire loop is physically associated with at least one feedlot feature.

74. The method as recited in claim 66, wherein the very low frequency radio signal and a least a second very low frequency radio signal are driven through a plurality of wire loops.

75. The method as recited in claim 66, further comprising driving a response through the wire loop when queried by a transceiver of the plurality of mobile transceivers.

76. The method as recited in claim 75, wherein the response comprises a frequency of about two and four-tenths gigahertz (2.4 GHz).

77. The method as recited in claim 65, wherein the plurality of mobile transceivers comprises a plurality of cattle ear tags.

78. The method as recited in claim 65, further comprising determining environmental information including at least one of a temperature, a humidity, or a position proximate to the base station.

79. A system for detecting a behavioral anomaly in a feed animal and indicating an intervention, the system comprising:

a wire loop to be physically associated with at least one feedlot feature, the feedlot feature capable of a behavioral interaction by the feed animal;

a wire driver for driving a very low frequency (VLF) radio signal through the wire loop;

a plurality of mobile transceivers, each one of the plurality of mobile transceivers capable of being worn by the feed animal and including:
at least one wire coil configured for a magnetic coupling with the wire loop by the very low frequency radio signal when sufficiently close to the wire loop,
circuitry for determining a magnetic field strength when magnetically coupled with the wire loop,
a processor for determining when to report a proximity to the wire loop based upon the determined magnetic field strength, and

an indicator for indicating the intervention for the feed animal;

a base station configured for bidirectional communications with the plurality of mobile transceivers and including at least one of a wireless computer networking interface or a mobile communications device interface for communicating information received from the plurality of mobile transceivers;

a data silo for storing historical data on the feed animal and its proximity to the wire loop communicated from the base station; and

a controller coupled with the data silo for analyzing the historical data on the feed animal to determine the behavioral anomaly in the feed animal associated with the intervention and instructing a mobile transceiver associated with the feed animal to indicate the intervention.

80. The system as recited in claim 79, wherein the feedlot feature comprises at least one of a feed trough, a water feature, or a gate.

81. The system as recited in claim 79, wherein the at least one wire coil comprises three (3) wire coils positioned at least substantially orthogonal to one another.

82. The system as recited in claim 79, wherein the base station comprises a radio frequency receiver configured to receive transmissions from the plurality of mobile transceivers within a plurality of timed reception slots, each one of the plurality of timed reception slots assignable to one of the plurality of mobile transceivers.

83. The system as recited in claim 82, wherein the base station comprises a radio frequency transmitter configured to broadcast an intermittent beacon signal to the plurality of mobile transceivers within a timed transmission slot, the intermittent beacon signal indicating timing of the timed transmission slot, timing of the plurality of timed reception slots, identifications of individual ones of the plurality of timed reception slots assigned to individual ones of the plurality of mobile transceivers, and identifications of individual ones of the plurality of timed reception slots that are unassigned; and a controller configured to analyze transmissions received from the plurality of mobile transceivers within the plurality of timed reception slots to identify a transmission from an unassigned mobile transceiver of the plurality of mobile transceivers received during an unassigned reception slot of the plurality of timed reception slots and assign the unassigned reception slot to the unassigned mobile transceiver.

84. The system as recited in claim 83, wherein the intermittent beacon signal comprises a radio frequency signal having a substantially higher frequency than the very low frequency radio signal driven through the wire loop.

85. The system as recited in claim 84, wherein the substantially higher frequency comprises a frequency of about two and four-tenths gigahertz (2.4 GHz).

86. The system as recited in claim 79, wherein the very low frequency radio signal comprises a frequency of between about five kilohertz (5 kHz) and about fifteen kilohertz (15 kHz).

87. The system as recited in claim 79, wherein the wire driver drives the very low frequency radio signal at a low voltage of between about three volts (3 V) and about fifteen volts (15 V).

88. The system as recited in claim 79, wherein the wire loop comprises a wire of between about fourteen (14) American wire gauge (AWG) and about twenty (20) American wire gauge.

89. The system as recited in claim 79, wherein the wire loop comprises a boundary wire at least five feet in length.

90. The system as recited in claim 79, wherein the wire driver is configured to drive the very low frequency radio signal through a plurality of wire loops.

91. The system as recited in claim 79, wherein the wire driver is configured to drive a response through the wire loop when queried by a transceiver of the plurality of mobile transceivers.

92. The system as recited in claim 91, wherein the response comprises a frequency of about two and four-tenths gigahertz (2.4 GHz).

93. The system as recited in claim 79, wherein the plurality of mobile transceivers comprises a plurality of cattle ear tags.

94. The system as recited in claim 79, wherein the base station further comprises at least one of a temperature sensor, a humidity sensor, or a position sensor for determining environmental information about an area occupied by the base station.

95. A method for detecting a behavioral anomaly in a feed animal and indicating an intervention, the method comprising:

physically associating a wire loop with at least one feedlot feature, the feedlot feature capable of a behavioral interaction by the feed animal;

driving a very low frequency (VLF) radio signal through the wire loop;

receiving transmissions from a plurality of mobile transceivers, each one of the plurality of mobile transceivers capable of being worn by the feed animal and including:
at least one wire coil configured for a magnetic coupling with the wire loop by the very low frequency radio signal when sufficiently close to the wire loop,
circuitry for determining a magnetic field strength when magnetically coupled with the wire loop,
a processor for determining when to report a proximity to the wire loop based upon the determined magnetic field strength, and

an indicator for indicating the intervention for the feed animal;

bidirectionally communicating with the plurality of mobile transceivers and communicating information received from the plurality of mobile transceivers through at least one of a wireless computer networking interface or a mobile communications device interface;

storing historical data on the feed animal and its proximity to the wire loop communicated through the through the at least one of the wireless computer networking interface or the mobile communications device interface; and

analyzing the historical data on the feed animal to determine the behavioral anomaly in the feed animal associated with the intervention and instructing a mobile transceiver associated with the feed animal to indicate the intervention.

96. The method as recited in claim 95, wherein the feedlot feature comprises at least one of a feed trough, a water feature, or a gate.

97. The method as recited in claim 95, wherein the at least one wire coil comprises three (3) wire coils positioned at least substantially orthogonal to one another.

98. The method as recited in claim 95, further comprising receiving transmissions from the plurality of mobile transceivers within a plurality of timed reception slots, each one of the plurality of timed reception slots assignable to one of the plurality of mobile transceivers.

99. The method as recited in claim 98, further comprising broadcasting an intermittent beacon signal to the plurality of mobile transceivers within a timed transmission slot, the intermittent beacon signal indicating timing of the timed transmission slot, timing of the plurality of timed reception slots, identifications of individual ones of the plurality of timed reception slots assigned to individual ones of the plurality of mobile transceivers, and identifications of individual ones of the plurality of timed reception slots that are unassigned; and analyzing transmissions received from the plurality of mobile transceivers within the plurality of timed reception slots to identify a transmission from an unassigned mobile transceiver of the plurality of mobile transceivers received during an unassigned reception slot of the plurality of timed reception slots and assign the unassigned reception slot to the unassigned mobile transceiver.

100. The method as recited in claim 99, wherein the intermittent beacon signal comprises a radio frequency signal having a substantially higher frequency than the very low frequency radio signal driven through the wire loop.

101. The method as recited in claim 100, wherein the substantially higher frequency comprises a frequency of about two and four-tenths gigahertz (2.4 GHz).

102. The method as recited in claim 95, wherein the very low frequency radio signal comprises a frequency of between about five kilohertz (5 kHz) and about fifteen kilohertz (15 kHz).

103. The method as recited in claim 95, wherein the very low frequency radio signal is driven at a low voltage of between about three volts (3 V) and about fifteen volts (15 V).

104. The method as recited in claim 95, wherein the wire loop comprises a wire of between about fourteen (14) American wire gauge (AWG) and about twenty (20) American wire gauge.

105. The method as recited in claim 95, wherein the wire loop comprises a boundary wire at least five feet in length.

106. The method as recited in claim 95, wherein the very low frequency radio signal is driven through a plurality of wire loops.

107. The method as recited in claim 95, further comprising driving a response through the wire loop when queried by a transceiver of the plurality of mobile transceivers.

108. The method as recited in claim 107, wherein the response comprises a frequency of about two and four-tenths gigahertz (2.4 GHz).

109. The method as recited in claim 95, wherein the plurality of mobile transceivers comprises a plurality of cattle ear tags.

110. The method as recited in claim 95, further comprising determining environmental information including at least one of a temperature, a humidity, or a position.

Generally, any of the functions described herein can be implemented using hardware (e.g., fixed logic circuitry such as integrated circuits), software, firmware, manual processing, or a combination thereof. Thus, the blocks discussed herein generally represent hardware (e.g., fixed logic circuitry such as integrated circuits), software, firmware, or a combination thereof. In the instance of a hardware configuration, the various blocks discussed herein may be implemented as integrated circuits along with other functionality. Such integrated circuits may include all of the functions of a given block, system, or circuit, or a portion of the functions of the block, system, or circuit. Further, elements of the blocks, systems, or circuits may be implemented across multiple integrated circuits. Such integrated circuits may comprise various integrated circuits, including, but not necessarily limited to: a monolithic integrated circuit, a flip chip integrated circuit, a multichip module integrated circuit, and/or a mixed signal integrated circuit. In the instance of a software implementation, the various blocks discussed herein represent executable instructions (e.g., program code) that perform specified tasks when executed on a processor. These executable instructions can be stored in one or more tangible computer readable media. In some implementations, the entire system, block, or circuit may be implemented using its software or firmware equivalent. In other implementations, one part of a given system, block, or circuit may be implemented in software or firmware, while other parts are implemented in hardware.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-47. (canceled)

48. A system for monitoring livestock behavior, the system comprising:
a wire loop to be physically associated with at least one feedlot feature, the feedlot feature capable of a behavioral interaction by the livestock;
a wire driver for driving a very low frequency (VLF) radio signal through the wire loop;
a plurality of mobile transceivers, each one of the plurality of mobile transceivers capable of being worn by the livestock and including:
at least one wire coil configured for a magnetic coupling with the wire loop by the very low frequency radio signal when sufficiently close to the wire loop,
circuitry for determining a magnetic field strength when magnetically coupled with the wire loop, and
a processor for determining when to report a proximity to the wire loop based upon the determined magnetic field strength;
a base station configured for bidirectional communications with the plurality of mobile transceivers and including at least one of a wireless computer networking interface or a mobile communications device interface for communicating information received from the plurality of mobile transceivers.

49. The system as recited in claim 48, wherein the feedlot feature comprises at least one of a feed trough, a water feature, or a gate.

50. The system as recited in claim 48, wherein the at least one wire coil comprises three (3) wire coils positioned at least substantially orthogonal to one another.

51. The system as recited in claim 48, wherein the base station comprises a radio frequency receiver configured to receive transmissions from the plurality of mobile transceivers within a plurality of timed reception slots, each one of the plurality of timed reception slots assignable to one of the plurality of mobile transceivers.

52. The system as recited in claim 51, wherein the base station comprises a radio frequency transmitter configured to broadcast an intermittent beacon signal to the plurality of mobile transceivers within a timed transmission slot, the intermittent beacon signal indicating timing of the timed transmission slot, timing of the plurality of timed reception slots, identifications of individual ones of the plurality of timed reception slots assigned to individual ones of the plurality of mobile transceivers, and identifications of individual ones of the plurality of timed reception slots that are unassigned; and a controller configured to analyze transmissions received from the plurality of mobile transceivers within the plurality of timed reception slots to identify a transmission from an unassigned mobile transceiver of the plurality of mobile transceivers received during an unassigned reception slot of the plurality of timed reception slots and assign the unassigned reception slot to the unassigned mobile transceiver.

53. The system as recited in claim 52, wherein the intermittent beacon signal comprises a radio frequency signal having a substantially higher frequency than the very low frequency radio signal driven through the wire loop.

54. The system as recited in claim 53, wherein the substantially higher frequency comprises a frequency of about two and four-tenths gigahertz (2.4 GHz).

55. The system as recited in claim 48, wherein the wire driver is configured to drive a response through the wire loop when queried by a transceiver of the plurality of mobile transceivers.

56. The system as recited in claim 55, wherein the response comprises a frequency of about two and four-tenths gigahertz (2.4 GHz).

57. The system as recited in claim 48, wherein the plurality of mobile transceivers comprises a plurality of cattle ear tags.

58. A system for establishing and maintaining communications with a multiplicity of mobile transceivers, the system comprising:
a plurality of mobile transceivers, each one of the plurality of mobile transceivers comprising:
a sensor configured to frequently determine characteristic information within an environment proximate to the mobile transceiver,
a limited memory configured to temporarily store the characteristic information, and
a controller configured to transmit the characteristic information from the mobile transceiver; and
a base station configured for bidirectional communications with the plurality of mobile transceivers, the base station comprising:
a radio frequency receiver configured to receive transmissions from the plurality of mobile transceivers within a plurality of timed reception slots, each one of the plurality of timed reception slots assignable to one of the plurality of mobile transceivers,
a radio frequency transmitter configured to broadcast an intermittent beacon signal to the plurality of mobile transceivers within a timed transmission slot, the intermittent beacon signal indicating timing of the timed transmission slot, timing of the plurality of timed reception slots, identifications of individual ones of the plurality of timed reception slots assigned to individual ones of the plurality of mobile transceivers, and identifications of individual ones of the plurality of timed reception slots that are unassigned, and
a controller configured to analyze transmissions received from the plurality of mobile transceivers within the plurality of timed reception slots to identify a transmission from an unassigned mobile transceiver of the plurality of mobile transceivers received during an unassigned reception slot of the plurality of timed reception slots and assign the unassigned reception slot to the unassigned mobile transceiver, wherein the characteristic information from the mobile transceiver can be transmitted from the mobile transceiver to the base station frequently enough to limit an amount of required storage space in the limited memory of the mobile transceiver.

59. The system as recited in claim 58, further comprising a wire driver for driving a very low frequency (VLF) radio signal through a wire loop.

60. The system as recited in claim 59, wherein the intermittent beacon signal comprises a radio frequency signal having a substantially higher frequency than the very low frequency radio signal driven through the wire loop.

61. The system as recited in claim 60, wherein the substantially higher frequency comprises a frequency of about two and four-tenths gigahertz (2.4 GHz).

62. The system as recited in claim 59, wherein the wire loop is physically associated with at least one feedlot feature.

63. The system as recited in claim 59, wherein the wire driver is configured to drive a response through the wire loop when queried by a transceiver of the plurality of mobile transceivers.

64. A system for detecting a behavioral anomaly in a feed animal and indicating an intervention, the system comprising:
a wire loop to be physically associated with at least one feedlot feature, the feedlot feature capable of a behavioral interaction by the feed animal;
a wire driver for driving a very low frequency (VLF) radio signal through the wire loop;
a plurality of mobile transceivers, each one of the plurality of mobile transceivers capable of being worn by the feed animal and including:
at least one wire coil configured for a magnetic coupling with the wire loop by the very low frequency radio signal when sufficiently close to the wire loop,
circuitry for determining a magnetic field strength when magnetically coupled with the wire loop,
a processor for determining when to report a proximity to the wire loop based upon the determined magnetic field strength, and
an indicator for indicating the intervention for the feed animal;
a base station configured for bidirectional communications with the plurality of mobile transceivers and including at least one of a wireless computer networking interface or a mobile communications device interface for communicating information received from the plurality of mobile transceivers;
a data silo for storing historical data on the feed animal and its proximity to the wire loop communicated from the base station; and
a controller coupled with the data silo for analyzing the historical data on the feed animal to determine the behavioral anomaly in the feed animal associated with the intervention and instructing a mobile transceiver associated with the feed animal to indicate the intervention.

65. The system as recited in claim 64, wherein the base station comprises a radio frequency receiver configured to receive transmissions from the plurality of mobile transceivers within a plurality of timed reception slots, each one of the plurality of timed reception slots assignable to one of the plurality of mobile transceivers.

66. The system as recited in claim 65, wherein the base station comprises a radio frequency transmitter configured to broadcast an intermittent beacon signal to the plurality of mobile transceivers within a timed transmission slot, the intermittent beacon signal indicating timing of the timed transmission slot, timing of the plurality of timed reception slots, identifications of individual ones of the plurality of timed reception slots assigned to individual ones of the plurality of mobile transceivers, and identifications of individual ones of the plurality of timed reception slots that are unassigned; and a controller configured to analyze transmissions received from the plurality of mobile transceivers within the plurality of timed reception slots to identify a transmission from an unassigned mobile transceiver of the plurality of mobile transceivers received during an unassigned reception slot of the plurality of timed reception slots and assign the unassigned reception slot to the unassigned mobile transceiver.

67. The system as recited in claim 66, wherein the intermittent beacon signal comprises a radio frequency signal having a substantially higher frequency than the very low frequency radio signal driven through the wire loop.
